(19) United States
(12) Patent Application Publication
(10) Pub. No.: US 2014/0359685 A1
(43) Pub. Date: Dec. 4, 2014

(54) VIDEO PROCESSING METHOD, TELEVISION DONGLE, CONTROL TERMINAL, AND SYSTEM

(71) Applicant: Huawei Technologies Co., Ltd., Shenzhen (CN)

(72) Inventor: Yongjun LIU, Chengdu (CN)

(73) Assignee: Huawei Technologies Co., Ltd., Shenzhen (CN)

(21) Appl. No.: 14/289,961

(22) Filed: May 29, 2014

(30) Foreign Application Priority Data
May 29, 2013 (CN) 201310207356.8

(51) Int. Cl. H04N 21/41

(52) U.S. Cl. CPC H04N 21/4104
USPC 725/110

(57) ABSTRACT

Embodiments of the present invention relate to a video processing method, a television dongle, and a control terminal. The method includes: receiving, by a television dongle, video information downloaded from the Internet; when a playing terminal needs to play the video information in a muted manner, decoding the video information, decomposing the decoded video information into video data and audio data, sending the decomposed video data to the playing terminal; and sending the decomposed audio data to a control terminal, so that the control terminal plays the audio data. Therefore, the present invention implements a function for a user to watch the picture of a video by using a playing terminal, for example, a television, and listen to the sound of the video by using a control terminal, for example, a smartphone, and reduces the cost for the user to watch video information in a muted manner.

### CROSS-REFERENCE TO RELATED APPLICATION

This application claims priority to Chinese Patent Application No. 201310207356.8, filed on May 29, 2013, which is hereby incorporated by reference in its entirety.

### TECHNICAL FIELD

The present invention relates to the field of communications technologies, and in particular, to a video processing method, a television dongle, a control terminal, and a system.

### BACKGROUND

A television dongle, which is also referred to as a High-Definition Multimedia Interface (HDMI) Dongle, has the same appearance as a USB flash drive, and is small and convenient to watch television programs from all around the world by using an in-built decoder. If the television dongle is inserted into an HDMI interface of a common television, the common television becomes a smart television which can be used to watch a movie, surf the Internet, play a game, listen to music, and the like. In short, the combination of a smart television dongle and a television, together with a universal mouse and keyboard, is equivalent to a computer having a large screen. Generally, an HDMI Dongle product is operated and controlled by using a remote control, and is mainly used for family entertainment.

At present, an HDMI Dongle is connected to a television by using an HDMI interface and connected to the Internet by using WIFI. An operation and control method in use may be performing operation and management by using management software on a smartphone, where the smartphone is interconnected with the HDMI Dongle by using WIFI, so that television programs from all around the world can be watched on the television. Moreover, in some specific scenarios, a wireless earphone may also be used to receive an audio signal from the television.

However, when a wireless earphone is used to receive an audio signal from a television, regarding an HDMI Dongle having a low cost, a playing terminal in cooperation with the wireless earphone greatly increases the cost.

### SUMMARY

The present invention provides a video processing method, a television dongle, a control terminal, and a system, so as to solve the problem in the prior art that when a wireless earphone is used to receive an audio signal from a television, regarding an HDMI Dongle having a low cost, a playing terminal in cooperation with the wireless earphone greatly increases the cost.

According to a first aspect, the present invention provides a video processing method, where the method includes: receiving video information downloaded from the Internet; decoding, when a playing terminal needs to play the video information in a muted manner, the video information, and decomposing the decoded video information into video data and audio data; and sending the video data to the playing terminal, and sending the audio data to a control terminal, so that the control terminal plays the audio data.

In a first possible implementation manner, the sending the audio data to a control terminal specifically is: sending the audio data to the control terminal by using a wireless fidelity WIFI network.

In a second possible implementation manner, the decoding, when a playing terminal needs to play the video information in a muted manner, the video information, and decomposing the decoded video information into video data and audio data further includes: decoding, when the playing terminal does not need to play the video information in a muted manner, the video information, and sending the decoded video information to the playing terminal, so that the playing terminal plays the decoded video information.

With reference to the first aspect, or with reference to the first possible implementation manner of the first aspect, or with reference to the second possible implementation manner of the first aspect, in a third possible implementation manner, the method further includes: receiving control information sent by the control terminal, where the control information includes mute control information or non-mute control information, the mute control information indicates that the playing terminal needs to play the video information in a muted manner, and the non-mute control information indicates that the playing terminal does not need to play the video information in a muted manner.

According to a second aspect, the present invention provides a video processing method, where the method includes: receiving, when a playing terminal needs to play video information in a muted manner, audio data that is sent by a television dongle and decomposed from the video information; and playing the audio data, so that an audio device provided by a user receives the audio data.

In a first possible implementation manner, the receiving audio data that is sent by a television dongle and decomposed from the video information specifically is: receiving, by using a wireless fidelity WIFI network, the audio data that is sent by the television dongle and decomposed from the video information.

With reference to the second aspect, or with reference to the first possible implementation manner of the second aspect, in a second possible implementation manner, the method further includes: receiving an instruction of the user, where the instruction includes a mute instruction or a non-mute instruction; and sending control information to the television dongle according to the instruction; when the instruction is the mute instruction, sending mute control information to the television dongle according to the mute instruction; and when the instruction is the non-mute instruction, sending non-mute control information to the television dongle according to the non-mute instruction.

According to a third aspect, the present invention provides a television dongle, where the television dongle includes: a first receiving unit, configured to receive video information downloaded from the Internet and transfer the video information to a decoding unit; the decoding unit, configured to receive the video information from the first receiving unit; when a playing terminal needs to play the video information in a muted manner, decode the video information, and decompose the decoded video information into video data and audio data; and transfer the video data and the audio data to a sending unit; and the sending unit, configured to receive the video data and the audio data from the decoding unit, send the video data to the playing terminal, and send the audio data to a control terminal, so that the control terminal plays the audio data.

In a first possible implementation manner, the sending unit is further configured to send the audio data to the control terminal by using a wireless fidelity WIFI network.

In a second possible implementation manner, the decoding unit is further configured to decode, when the playing terminal does not need to play the video information in a muted manner, the video information, and send the decoded video information to the sending unit; and the sending unit is further configured to receive the decoded the decoded video information from the decoding unit, and send the video information to the playing terminal, so that the playing terminal plays the decoded video information.

With reference to the third aspect, or with reference to the first possible implementation manner of the third aspect, or with reference to the second possible implementation manner of the third aspect, in a third possible implementation manner, the television dongle further includes: a second receiving unit, configured to receive mute control information or non-mute control information sent by the control terminal, where the mute control information indicates that the playing terminal needs to play the video information in a muted manner, and the non-mute control information indicates that the playing terminal does not need to play the video information in a muted manner.

According to a fourth aspect, the present invention provides a control terminal, where the terminal includes: a first receiving unit, configured to receive, when a playing terminal needs to play video information in a muted manner, audio data that is sent by a television dongle and decomposed from the video information, and transfer the audio data to a playing unit; and the playing unit, configured to receive the audio data from the first receiving unit, and play the audio data, so that an audio device provided by a user receives the audio data.

In a first possible implementation manner, the first receiving unit is further configured to receive, by using a wireless fidelity WIFI network, the audio data that is sent by the television dongle and decomposed from the video information.

With reference to the fourth aspect, or with reference to the first possible implementation manner of the fourth aspect, in a second possible implementation manner, the control terminal further includes: a second receiving unit, configured to receive an instruction of the user, where the instruction includes a mute instruction or a non-mute instruction, and transfer the instruction to a sending unit; and the sending unit, configured to receive the instruction from the second receiving unit; when the instruction is the mute instruction, send mute control information to the television dongle according to the mute instruction; and when the instruction is the non-mute instruction, send non-mute control information to the television dongle according to the non-mute instruction.

According to a fifth aspect, the present invention provides a video processing system, where the system includes the television dongle provided in the third aspect, the control terminal provided in the fourth aspect, and a playing terminal.

By using a video processing method, a television dongle, a control terminal, and a system disclosed in the present invention, a television dongle receives video information downloaded from the Internet; when a playing terminal needs to play the video information in a muted manner, decodes the video information, decomposes the decoded video information into video data and audio data, sends the video data to the playing terminal, and sends the audio data to a control terminal, so that the control terminal plays the audio data. This implements a function for a user to watch the picture of a video by using the playing terminal, for example, a television, and listen to the sound of the video by using the control terminal, for example, a smartphone, and reduces the cost for the user to watch the video information in a muted manner.

### BRIEF DESCRIPTION OF DRAWINGS

FIG. 1 is a flowchart of a video processing method provided by Embodiment 1 of the present invention;

FIG. 2 is a flowchart of a video processing method provided by Embodiment 2 of the present invention;

FIG. 3 is a schematic diagram of a television dongle provided by Embodiment 3 of the present invention;

FIG. 4 is a schematic diagram of a control terminal provided by Embodiment 4 of the present invention;

FIG. 5 is a schematic diagram of a television dongle provided by Embodiment 5 of the present invention;

FIG. 6 is a schematic diagram of a control terminal provided by Embodiment 6 of the present invention; and

FIG. 7 is a schematic diagram of a video processing system provided by Embodiment 7 of the present invention.

### DESCRIPTION OF EMBODIMENTS

To make the objectives, technical solutions, and advantages of the embodiments of the present invention more clearly, the following clearly describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present invention.

The present invention discloses a video processing method, a television dongle, a control terminal, and a system, where a television dongle receives video information downloaded from the Internet; when a playing terminal needs to play the video information in a muted manner, decodes the video information, decomposes the decoded video information into video data and audio data, sends the video data to the playing terminal, and sends the audio data to a control terminal, so that the control terminal plays the audio data. This implements a function for a user to watch the picture of a video by using the playing terminal, for example, a television, and listen to the sound of the video by using the control terminal, for example, a smartphone, and reduces the cost for the user to watch the video information in a muted manner.

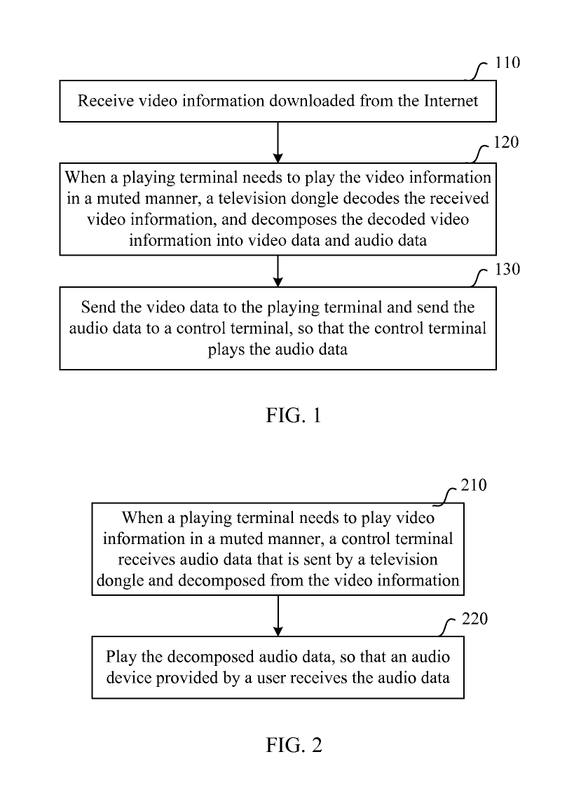

FIG. 1 is a flowchart of a video processing method provided by Embodiment 1 of the present invention. As shown in FIG. 1, the embodiment of the present invention specifically includes the following steps:

Step 110: A television dongle receives video information downloaded from the Internet, such as a television program from all around the world. The television dongle may be connected to the Internet by using a high-speed interconnection mode such as wireless fidelity (WIFI).

Step 120: When a playing terminal needs to play the video information in a muted manner, the television dongle decodes the received video information, and decomposes the decoded video information into video data and audio data. Whether the playing terminal needs to play the video information in a muted manner is determined according to control information that is stored locally and sent by a control terminal. The control information includes mute control information or non-mute control information, where the mute control information indicates that the playing terminal needs to play the video information in a muted manner, and the non-mute control information indicates that the playing terminal does not need to play the video information in a muted manner.

Specifically, when the playing terminal plays the video information, for example, when a television plays a television program, a scenario is likely to occur where the sound played by the television disturbs other people. In such cases, the sound played by the television needs to be muted, that is, the playing terminal needs to play the video information in a muted manner. In order to satisfy the demand of a user on the sound of the video information, the television dongle decodes the video information and decomposes the decoded video information into video data and audio data, and plays the video data and the audio data by using different terminal devices.

Further, step 120 further includes: decoding, when the playing terminal does not need to play the video information in a muted manner, the video information, and sending the decoded video information to the playing terminal, so that the playing terminal plays the decoded video information.

Step 130: The television dongle sends the video data to the playing terminal, for example, a television, and sends the audio data to a control terminal, for example, a smartphone, so that the control terminal plays the audio data.

Specifically, the television dongle is connected to the playing terminal by using an HDMI Therefore, the television dongle sends the video data to the television through the HDMI interface, and sends the audio data to the smartphone, thereby implementing that the audio data is played by using the smartphone. This allows the user to receive the audio data by using an earphone of the mobile phone, thereby achieving an effect for the user to watch the picture of a video by using the television and listen to the sound of the video by using the earphone of the mobile phone. Moreover, a smartphone usually is provided with an earphone, and the user does not need to buy an additional earphone.

Further, step 130 further includes: sending, by the television dongle by using a WIFI network, the audio data to the control terminal, for example, a smartphone.

In addition, the video processing method provided by the embodiment of the present invention further includes: receiving, by the television dongle, control information sent by the control terminal, and storing the control information, where the control information includes mute control information or non-mute control information, the mute control information indicates that the playing terminal needs to play the video information in a muted manner, and the non-mute control information indicates that the playing terminal does not need to play the video information in a muted manner.

The control information is control information formulated by the control terminal according to an instruction of the user. The instruction of the user includes a mute instruction or a non-mute instruction, where when the instruction is the non-mute instruction, mute control information is sent to the television dongle according to the mute instruction; and when the instruction is the non-mute instruction, non-mute control information is sent to the television dongle according to the non-mute instruction.

A process for the control terminal to receive the instruction of the user normally is as follows: When the user starts a software protector Dongle management apparatus on the smartphone and configures a Dongle parameter, for example, configures a mute mode parameter, the configured Dongle parameter is the instruction of the user. The control terminal analyzes the Dongle parameter and sends control information corresponding to the Dongle parameter to the television dongle. When a mute mode parameter is configured, the instruction of the user is a mute instruction, and therefore the control terminal sends mute control information carrying the mute mode parameter to the television dongle; and when a non-mute mode parameter is configured, the instruction of the user is a non-mute instruction, and therefore the control terminal sends non-mute control information carrying the non-mute mode parameter to the television dongle. In addition, when receiving no television dongle control information, including mute control information or non-mute control information, sent by the control terminal, the television dongle decodes, in a default state, the video information, and sends the decoded video information to the playing terminal, so that the playing terminal plays the decoded video information.

Therefore, in the video processing method provided by the embodiment of the present invention, a television dongle is used to receive video information downloaded from the Internet; when a playing terminal needs to play the video information in a muted manner, decode the video information, decompose the decoded video information into video data and audio data, send the video data to the playing terminal, and send the audio data to a control terminal, so that the control terminal plays the audio data. This implements a function for a user to watch the picture of a video by using the playing terminal, for example, a television, and listen to the sound of the video by using the control terminal, for example, a smartphone, and reduces the cost for the user to watch the video information in a muted manner.

FIG. 2 is a flowchart of a video processing method provided by Embodiment 2 of the present invention. As shown in FIG. 2, the embodiment of the present invention specifically includes the following steps:

Step 210: When a playing terminal needs to play video information in a muted manner, a control terminal receives audio data that is sent by a television dongle and decomposed from the video information.

Further, step 210 further includes receiving, by using a wireless fidelity WIFI network, the audio data that is sent by the television dongle and decomposed from the video information.

Step 220: The control terminal, for example, a smartphone, plays the decomposed audio data, so that an audio device provided by a user receives the audio data. The audio device may be an earphone of the smartphone.

In addition, the video processing method provided by the embodiment of the present invention further includes: receiving, by the control terminal, an instruction of the user, where the instruction includes a mute instruction or a non-mute instruction; sending control information to the television dongle according to the instruction; when the instruction is the mute instruction, sending mute control information to the television dongle according to the mute instruction; and when the instruction is the non-mute instruction, sending non-mute control information to the television dongle according to the non-mute instruction.

Specifically, a process for the control terminal to receive the instruction of the user normally is as follows: When the user starts a software protector Dongle management apparatus on the smartphone and configures a Dongle parameter, for example, configures a mute mode parameter, the configured Dongle parameter is the instruction of the user. The control terminal analyzes the Dongle parameter and sends control information corresponding to the Dongle parameter to the television dongle. When a mute mode parameter is configured, the instruction of the user is a mute instruction, and therefore the control terminal sends mute control information carrying the mute mode parameter to the television dongle; and when a non-mute mode parameter is configured, the instruction of the user is a non-mute instruction, and therefore the control terminal sends non-mute control information carrying the non-mute mode parameter to the television dongle.

Therefore, in the video processing method provided by the embodiment of the present invention, when a playing terminal needs to play video information in a muted manner, a control terminal receives audio data that is sent by a television dongle and decomposed from the video information, and plays the audio data, so that an audio device provided by a user receives the audio data. This implements a function for the user to listen to the sound of a video by using a control terminal, for example, a smartphone, and reduces the cost for the user to watch the video information in a muted manner.

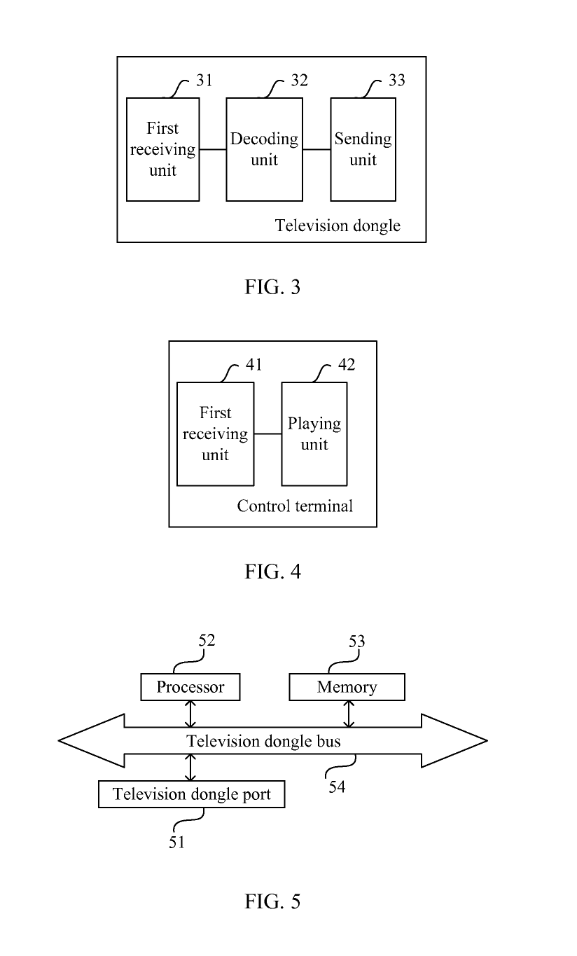

FIG. 3 is a schematic diagram of a television dongle provided by Embodiment 3 of the present invention. The television dongle is used to execute the video processing method provided by Embodiment 1 of the present invention. As shown in FIG. 3, the embodiment of the present invention specifically includes a first receiving unit 31, a decoding unit 32, and a sending unit 33.

The first receiving unit 31 is configured to receive video information downloaded from the Internet and transfer the video information to the decoding unit 32. The decoding unit 32 is configured to receive the video information from the first receiving unit 31; when a playing terminal needs to play the video information in a muted manner, decode the video information, and decompose the decoded video information into video data and audio data; and transfer the video data and the audio data to the sending unit 33. The sending unit 33 is configured to receive the video data and the audio data from the decoding unit 32, send the video data to the playing terminal, and send the audio data to a control terminal, so that the control terminal plays the audio data.

The decoding unit 32 is further configured to decode, when the playing terminal does not need to play the video information in a muted manner, the video information; and the sending unit 33 is further configured to send the decoded video information to the playing terminal, so that the playing terminal plays the decoded video information.

Further, the sending unit 33 is further configured to send, by using a WIFI network, the audio data to the control terminal, for example, a smartphone.

In addition, the television dongle provided by the embodiment of the present invention further includes a second receiving unit 34.

The second receiving unit 34 is configured to receive mute control information or non-mute control information sent by the control terminal, where the mute control information indicates that the playing terminal needs to play the video information in a muted manner, and the non-mute control information indicates that the playing terminal does not need to play the video information in a muted manner.

Therefore, the television dongle provided by the embodiment of the present invention receives video information downloaded from the Internet; when a playing terminal needs to play the video information in a muted manner, decodes the video information, decomposes the decoded video information into video data and audio data, sends the video data to the playing terminal, and sends the audio data to a control terminal, so that the control terminal plays the audio data. This implements a function for a user to watch the picture of a video by using the playing terminal, for example, a television, and listen to the sound of the video by using the control terminal, for example, a smartphone, and reduces the cost for the user to watch the video information in a muted manner.

FIG. 4 is a schematic diagram of a control terminal provided by Embodiment 4 of the present invention. The control terminal is used to execute the video processing method provided by Embodiment 2 of the present invention. As shown in FIG. 4, the embodiment of the present invention specifically includes a first receiving unit 41 and a playing unit 42.

The first receiving unit 41 is configured to receive, when a playing terminal needs to play video information in a muted manner, audio data that is sent by a television dongle and decomposed from the video information, and transfer the audio data to the playing unit 42. The playing unit 42 is configured to receive the audio data from the first receiving unit 41, and play the audio data, so that an audio device provided by a user receives the audio data.

The first receiving unit 41 is further configured to receive, by using a wireless fidelity WIFI network, the audio data that is sent by the television dongle and decomposed from the video information.

Further, the control terminal provided by the embodiment of the present invention further includes a second receiving unit 43 and a sending unit 44.

The second receiving unit 43 is configured to receive an instruction of the user, where the instruction includes a mute instruction or a non-mute instruction, and transfer the instruction to the sending unit 44.

The sending unit 44 is configured to receive the instruction from the second receiving unit; when the instruction is the mute instruction, send mute control information to the television dongle according to the mute instruction; and when the instruction is the non-mute instruction, send non-mute control information to the television dongle according to the non-mute instruction.

Therefore, the control terminal provided by the embodiment of the present invention receives, when a playing terminal needs to play video information in a muted manner, audio data that is sent by a television dongle and decomposed from the video information, and plays the audio data, so that an audio device provided by a user receives the audio data. This implements a function for the user to listen to the sound of the video by using a control terminal, for example, a smartphone, and reduces the cost for the user to watch the video information in a muted manner.

FIG. 5 is a schematic diagram of a television dongle provided by Embodiment 5 of the present invention. The television dongle is used to execute the video processing method provided by Embodiment 1 of the present invention. As shown in FIG. 5, the embodiment of the present invention specifically includes a television dongle port 51, a processor 52, a memory 53, and a television dongle bus 54. The television dongle bus 54 is configured to connect the television dongle port 51, the processor 52, and the memory 53.

The television dongle port 51 is connected to a playing terminal and a control terminal. The television dongle is connected to the playing terminal, for example, a television, by using an HDMI interface, and is connected to the control terminal, for example, a smartphone, by using a WIFI network. In addition, the television dongle is connected to the Internet by using the WIFI network.

The memory 53 may be a permanent memory, for example, a hard disk drive and a flash memory. The memory 53 has a software module and a device driver program. The software module can execute the various functional modules in the foregoing methods according to the present invention; and the device driving program may be a network and interface driving program.

Upon startup, these software components are loaded to the memory 53, and then are invoked by the processor 52 to execute the method illustrated in FIG. 1.

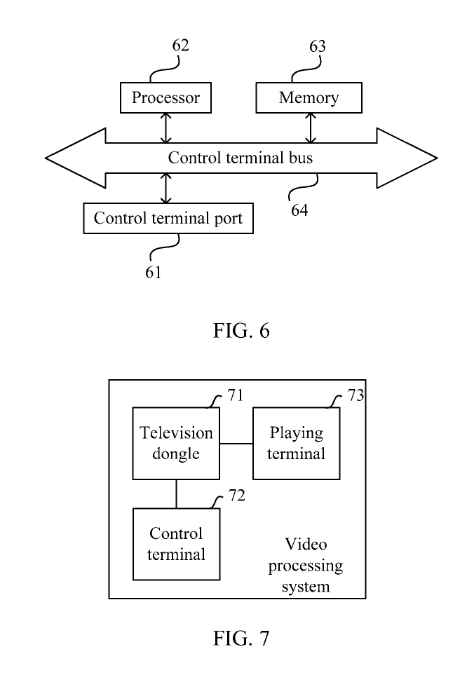

FIG. 6 is a schematic diagram of a control terminal provided by Embodiment 6 of the present invention. The control terminal is used to execute the video processing method provided by Embodiment 2 of the present invention. As shown in FIG. 6, the embodiment of the present invention specifically includes a control terminal port 61, a processor 62, a memory 63, and a control terminal bus 64. The control terminal bus 64 is configured to connect the control terminal port 61, the processor 62, and the memory 63.

The control terminal port 61 is connected to the television dongle. The control terminal, for example, a smartphone, is connected to the television dongle by using a WIFI network.

The memory 63 may be a permanent memory, for example, a hard disk drive and a flash memory. The memory 63 has a software module and a device driving program. The software module can execute the various functional modules in the foregoing methods according to the present invention; and the device driving program may be a network and interface driving program.

Upon startup, these software components are loaded to the memory 63, and then are invoked by the processor 62 to execute the method illustrated in FIG. 2.

FIG. 7 is a schematic diagram of a video processing system provided by Embodiment 7 of the present invention. This system is used to execute the video processing methods provided by Embodiment 1 and Embodiment 2 of the present invention. As shown in FIG. 7, the embodiment of the present invention specifically includes a television dongle 71, a control terminal 72, and a playing terminal 73. The television dongle 71 is connected to the playing terminal 73, for example, a television, by using an HDMI interface, and is connected to the control terminal 72, for example, a smartphone, by using a WIFI network. In addition, the television dongle 71 is connected to the Internet by using the WIFI network.

Therefore, the video processing system provided by the embodiment of the present invention implements a function for a user to receive the sound of a video by using a control terminal, for example, a smartphone, and reduces the cost for the user to watch video information in a muted manner.

A person skilled in the art should be able to further note that the method steps and units with reference to the description in the embodiments disclosed herein may be implemented by using electronic hardware, computer software, or a combination thereof, and in order to clearly describe interchangeability of hardware and software, the above description describes steps and combinations of various embodiments generally according to functions. Whether the functions are performed by hardware or software depends on the particular applications and design constraint conditions of the technical solution. A person skilled in the art may use different methods to implement the described functions for each particular application, but it should not be considered that the implementation goes beyond the scope of the present invention.

The method steps with reference to the description of the embodiments disclosed herein may be implemented by using hardware, a software module to be executed by a processor, or a combination thereof. The software module may be placed in a random access memory (RAM), a memory, a read-only memory (ROM), an electrically programmable ROM, and an electrically erasable programmable ROM, a register, a hard disk, a removable magnetic disk, a CD-ROM, or any storage medium of other forms well-known in the art.

The above specific embodiments further describe the objective, technical solutions, and beneficial effects of the present invention in detail. It should be understood that the above are merely specific embodiments of the present invention, and are not intended to limit the protection scope of the present invention. Any modifications, equivalent replacements, and improvements made without departing from the spirit and principle of the present invention shall fall within the scope of the present invention.

1. A video processing method, comprising:
receiving video information;
in response to a playing terminal needing to play the video information in a muted manner, decoding the video information into first decoded video information;
decomposing the first decoded video information into video data and audio data;
sending the video data to the playing terminals; and
sending the audio data to a control terminal, so that the control terminal plays the audio data.

2. The video processing method according to claim 1, wherein the sending the audio data to the control terminal comprises:
sending the audio data to the control terminal by using a wireless network.

3. The video processing method according to claim 1, further comprising:
in response to the playing terminal not needing to play the video information in a muted manner, decoding the video information into second decoded video information, and
sending the second decoded video information to the playing terminal, so that the playing terminal plays the second decoded video information.

4. The video processing method according to claim 1, further comprising:
receiving control information sent by the control terminal, wherein the control information comprises mute control information or non-mute control information, the mute control information indicates that the playing terminal needs to play the video information in a muted manner, and the non-mute control information indicates that the playing terminal does not need to play the video information in a muted manner.

5. A video processing method, comprising:
receiving, when a playing terminal needs to play video information in a muted manner, audio data that is sent by a television dongle and decomposed from the video information; and
playing the audio data, so that an audio device provided by a user receives the audio data.

6. The video processing method according to claim 5, wherein the receiving audio data that is sent by the television dongle and decomposed from the video information comprises:
receiving, by using a wireless network, the audio data that is sent by the television dongle and decomposed from the video information.

7. The video processing method according to claim 5, further comprising:
receiving an instruction of the user, wherein the instruction comprises a mute instruction or a non-mute instruction; and
when the instruction is the mute instruction, sending mute control information to the television dongle according to the mute instruction; and
when the instruction is the non-mute instruction, sending non-mute control information to the television dongle according to the non-mute instruction.

8. A television dongle, comprising:
a first receiving unit, configured to receive video information and transfer the video information to a decoding unit;
the decoding unit, configured to:
receive the video information from the first receiving unit,
in response to a playing terminal needing to play the video information in a muted manner, decode the video information into first decoded information, and
decompose the first decoded video information into video data and audio data, and
transfer the video data and the audio data to a sending unit; and
the sending unit, configured to receive the video data and the audio data from the decoding unit, send the video data to the playing terminal, and send the audio data to a control terminal, so that the control terminal plays the audio data.

9. The television dongle according to claim 8, wherein the sending unit is further configured to send the audio data to the control terminal by using a wireless network.

10. The television dongle according to claim 8, wherein
the decoding unit is further configured to decode, when the playing terminal does not need to play the video information in a muted manner, the video information into second decoded video information, and send the second decoded video information to the sending unit; and
the sending unit is further configured to receive the second decoded video information from the decoding unit, and send the second decoded video information to the playing terminal, so that the playing terminal plays the second decoded video information.

11. The television dongle according to claim 8, further comprising:
a second receiving unit, configured to receive mute control information or non-mute control information sent by the control terminal, wherein the mute control information indicates that the playing terminal needs to play the video information in a muted manner, and the non-mute control information indicates that the playing terminal does not need to play the video information in a muted manner.

12. A control terminal, comprising:
a first receiving unit, configured to receive, when a playing terminal needs to play video information in a muted manner, audio data that is sent by a television dongle and decomposed from the video information, and transfer the audio data to a playing unit; and
the playing unit, configured to receive the audio data from the first receiving unit, and play the audio data, so that an audio device provided by a user receives the audio data.

13. The control terminal according to claim 12, wherein the first receiving unit is further configured to receive, by using a wireless network, the audio data that is sent by the television dongle and decomposed from the video information.

14. The control terminal according to claim 12, further comprising:
a second receiving unit, configured to receive an instruction of the user, wherein the instruction comprises a mute instruction or a non-mute instruction, and transfer the instruction to a sending unit; and
the sending unit, configured to receive the instruction from the second receiving unit; when the instruction is the mute instruction, send mute control information to the television dongle according to the mute instruction; and when the instruction is the non-mute instruction, send non-mute control information to the television dongle according to the non-mute instruction.

15. The video processing method according to claim 1, wherein the video information is downloaded from the Internet.

16. The television dongle according to claim 8, wherein the video information is downloaded from the Internet.
